(19) United States
(12) Patent Application Publication
(10) Pub. No.: US 2026/0187580 A1
(43) Pub. Date: Jul. 2, 2026

(54) FULLY AUTONOMOUS SENSOR NETWORK TRIP INTELLIGENCE SYSTEM AND METHOD

(71) Applicant: CHORUSVIEW, INC., LAS VEGAS, NV (US)

(72) Inventors: Randell Cotta, San Mateo, CA (US); Geoffrey Anders, San Francisco, CA (US); Sahaana Suri, Dublin, CA (US); Oulin Yao, Superior, CO (US)

(21) Appl. No.: 19/006,558

(22) Filed: Dec. 31, 2024

(51) Int. Cl. G06Q 10/0833; G06Q 10/04

(52) U.S. Cl. CPC G06Q 10/0833; G06Q 10/04

(57) ABSTRACT

Aspects of the disclosure relate to software systems of a tracking system configured to process data from tracking tags affixed to assets to be tracked. The software systems may be used to process data such as payloads, interact with various systems including client facing systems, and make predictions regarding tracked assets. The predictions may provide information regarding the status of the tracked assets during trips. The predictions regarding the trips may include destinations of the assets during the trips, events occurring during the trips, conditions of the assets during the trip, estimated time of arrival at the one or more destinations, etc. The software systems may be robust such that these predictions may be made with minimal or no information pertaining to the trips beyond payloads from tracking tags affixed to the assets to be tracked.

### BACKGROUND

The Internet of Things (IoT) is the inter-networking of physical objects, such as products, packages, vehicles, buildings, etc., that are embedded with electronic components for network connectivity. The embedded components enable objects to detect others, be detected by others, collect data and/or transmit data. In some examples, the embedded components may include tags or labels attached to the physical objects. These tags or labels may be passive or active. The inter-networking capabilities may be leveraged for tracking assets within a system. In many situations, objects may change in state (e.g., temperature), may be moved from one zone to another, or may be moved from one physical location to another at different points in time, such as a package or equipment moved from a truck to a loading dock to a warehouse, or medical equipment that is moved between different rooms (or floors) in a hospital. In these types of situations, it can be very challenging to determine the status of the object with suitable accuracy, including updating the status as that status changes. In addition, these situations may include wide situational variability that increase the challenges of tracking.

Generally, substantial input from customers may be required in making predictions regarding asset status. However, different customers may have limited and varied ability to provide data regarding the expected status of assets or to independently know when the actual status has deviated from an expected status. Additionally, such data may not be accurate or verifiable by the system.

### BRIEF SUMMARY

Aspects of the disclosure provide a method. The method includes receiving one or more payloads from one or more reader devices of an asset tracking system, wherein the one or more payloads include data pertaining to a status of at least one asset being tracked by the asset tracking system, the data including at least location information; generating one or more token sequences based on the data included in the one or more payloads, wherein each generated token sequence includes one or more labels associated with the data; calling, by an event orchestrion platform, a first machine learning (ML) model to generate a first prediction pertaining to the status of the at least one asset being tracked by the system, wherein the calling is based on at least one of i) receipt, by the asset tracking system, of a payload or ii) a prior generated prediction by a second ML model; and in response to the calling, generating, by the first ML model, the first prediction based on the one or more token sequences.

In one example, the first ML model may be one of a trip inference model, a trip anomaly detection model, a destination recommendation model, an estimated time of arrival model, a conditions forecasting model, and a delivery detection model. Additionally, the first ML model may be the delivery detection model, wherein the delivery detection model is configured to predict when a delivery of a tracked asset has occurred. Additionally, the prediction of the delivery occurrence may be based at least one of: a geofence break, condition changes, “seen-by” events, and shipment-based network changes.

In another example, the one or more payloads may be received from a tracking tag affixed to the at least one asset.

In a further example, the data may pertain to a plurality of assets being tracked by the asset tracking system.

In an additional example, generating the one or more token sequences may include grouping the data based on a time interval when the data is received or grouping the data into buckets, wherein each bucket includes a collection of a predetermined number of data points; and averaging each group of the data.

In another example, generating the one or more token sequences may include generating a first plurality of tokens including a first type of information and a second plurality of tokens including a second type of information; and concatenating the first plurality of tokens and the second plurality of tokens to generate a token sequence of the one or more token sequences. Additionally, each token of the one or more token sequences includes the first type of information and the second type of information.

In an additional example, the method may further include generating one or more alerts based on the first prediction; and triggering an action based on the first prediction.

In a further example, calling, by the event orchestration platform, the first ML to generate the first prediction may include calling a third ML model to make a third prediction; and generating, by the first ML model, the first prediction may be further based on the third prediction.

In another example, the method may further include calling, by the event orchestrion platform, a model inference service (MIS) configured to fetch one or more ML models; and fetching by the MIS, a primary version of the first ML model and a secondary version of the first ML model; wherein generating the first prediction based on the one or more token sequences includes generating a primary first prediction using the primary version of the first ML model and a secondary first prediction using the secondary first ML model.

In an additional example, the data may further include one or more sensor measurements; and at least one label of the one or more labels may correspond to the one or more sensor measurements.

In another example, at least one label of the one or more labels may correspond to one or more specialized events.

In a further example, the first ML model and the second ML model may be the same. Alternatively, the first ML model and the second ML model may be different.

In an additional example, the status of the at least one asset may pertain to movement of the at least one asset from a point of origin to one or more final destinations or from a first state of the asset to a second state of the asset.

In another example, the method may further include training the first ML model using non-specific training data. Additionally, the method may further include training the first ML model using customer-specific training data

Another aspect of the disclosure is directed towards an asset tracking system. The asset tracking system including one or more tracking tags configured to generate one or more payloads including data pertaining a status of at least one asset being tracked by the asset tracking system, wherein the data includes at least location information; one or more readers configured to receive one or more payloads from the one or more tracking tags; and one or more processors. The one or more processors configured to: receive one or more payloads from the one or more reader devices, generate one or more token sequences based on the data included in the received one or more payloads, wherein each generated token sequence includes one or more labels associated with the data, call, by an event orchestrion platform, a first machine learning (ML) model to generate a first prediction pertaining to the status of the at least one asset being tracked by the system, wherein the calling is based on at least one of i) receipt, by the asset tracking system, of a payload or ii) a prior generated prediction by a second ML model, and in response to the call, generate, by the first ML model, the first prediction based on the one or more token sequences.

### BRIEF DESCRIPTION OF DRAWINGS

FIG. 1A illustrates various examples for localization of objects in accordance with aspects of the disclosure.

FIG. 1B is a functional diagram of an example tracking system in accordance with aspects of the disclosure.

FIG. 2 is a pictorial diagram of an example network in accordance with aspects of the disclosure.

FIG. 3 is a functional diagram of the example network in FIG. 2 in accordance with aspects of the disclosure.

FIG. 4A illustrates example scenarios in accordance with aspects of the disclosure.

FIG. 4B illustrates another example of a system having a number of fixed tracking tags positioned along different aisles in a warehouse setting.

FIG. 5 is an example functional diagram of a tracking tag, reader devices, and server computing devices in accordance with aspects of the disclosure.

FIG. 6 depicts an example software system in server computing devices in accordance with aspects of the disclosure.

FIG. 7A depicts an example trace tokenization module in accordance with aspects of the disclosure.

FIG. 7B depicts an example partial token sequence in accordance with aspects of the disclosure.

FIG. 8 depicts an example call tree of the event orchestration platform in accordance with aspects of the disclosure.

FIG. 9 depicts an example delivery detection machine learning model in accordance with aspects of the disclosure.

FIG. 10 depicts an example machine learning model training framework in accordance with aspects of the disclosure.

FIG. 11 is an example flow diagram in accordance with aspects of the disclosure

### DETAILED DESCRIPTION

### Overview

Aspects of the disclosure relate to software systems of a tracking system configured to process data (e.g., payloads) from tracking tags affixed to assets to be tracked. The software systems may be used to process data such as payloads, interact with various systems including client facing systems, and make predictions regarding tracked assets. The predictions may provide information regarding the status of the tracked assets during trips. A given trip may involve the collective movement of a set of assets from a point of origin to one or more final destinations. In one example, the point of origin may be a first location and the one or more final destinations may be one or more second locations. Additionally or alternatively, the point of origin may be a first zone at a location (e.g., a zone within a building) and the one or more final destinations may be one or more second zones. In another example, a given trip may include transitions from one asset state to another. In this regard the point of origin may be a first state and the one or more final destinations may be one or more second states. The states may include, for example, a threshold number of assets may be at a particular location or zone, a condition of the asset (e.g., temperature), etc.

The predictions regarding the trips may include one or more destinations of the assets during the trips, events occurring during the trips, conditions of the assets during the trip, estimated time of arrival at the one or more destinations, etc. The software systems may be robust such that these predictions may be made with minimal or no information pertaining to the trips beyond payloads from tracking tags affixed to the assets to be tracked.

The systems and methodology described herein allow for a fully autonomous system for tracking assets including asset tags thereon. The system allows for such tracking with minimal to no input from users of customers of the system. Such a robust system is desirable to enable accurate tracking of assets and prediction of trip details without need for user inputs. Additionally, such a robust system may allow for validation of customer provided plans or routes. In this regard, when provided the system may validate the plans or routes as well as to incorporate the inputted plans or route as data in order to modify the system behavior. For example, if a customer provides there are ten assets on a trip, the system may check this with respect to received payloads and provide an alert if, for example, one or more assets were left behind on a trip In another example, if a customer provides a trip will involve a stop sequence A, B, C, D the system may both i) take that as input to improve predictions (e.g., ETA to C knowing that we will stop at A/B first) and ii) check that this sequence actually happens and alert there is a deviation from this sequence. In this regard, customers may be provided systems and methodology to accurately track assets both with and without input.

### Example Systems

### Example Tracking Systems

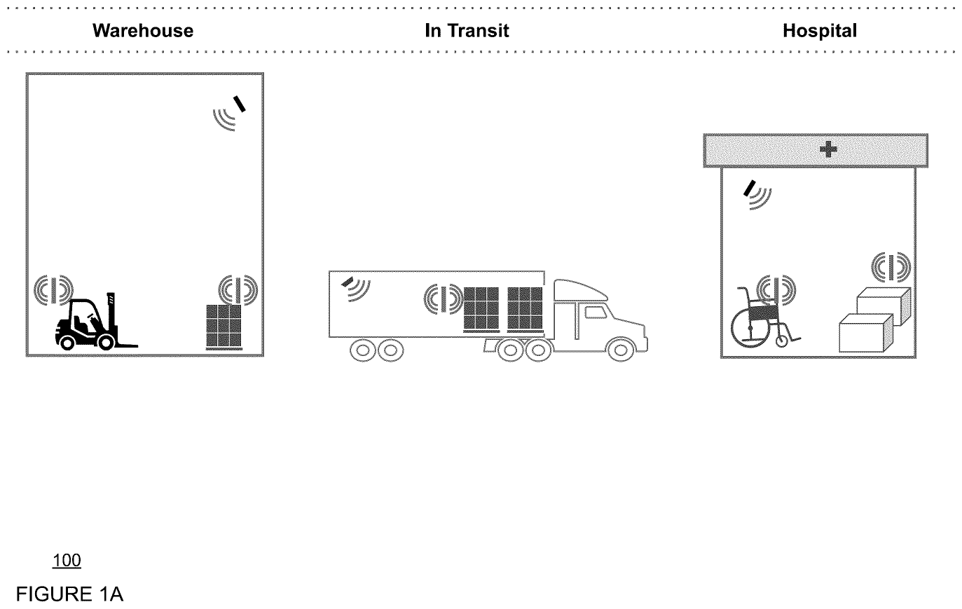

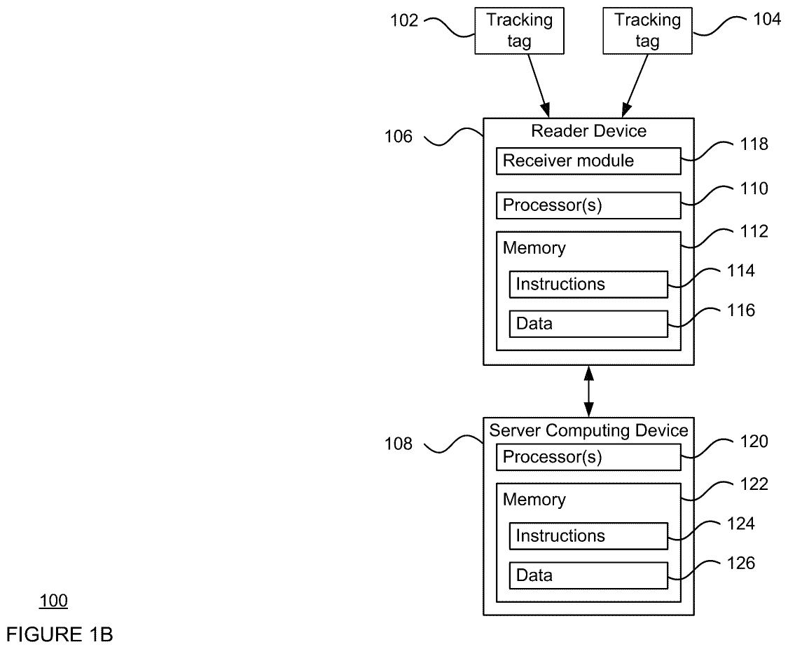

FIG. 1A illustrates examples of different objects in various environments. As shown on the left side image of the figure, there may be packages or equipment on a pallet in a warehouse. The pallet may have come off of a cargo truck as shown by the “In Transit” image in the middle of the figure. The pallet may be moved to one or more different locations within a warehouse, such as by the forklift shown in the left side image. The right-side image in the figure illustrates a situation where medical equipment (e.g., a wheelchair) and supplies in boxes may be stored in a supply room in a hospital.

In all of these situations-in the warehouse, on the cargo truck, or at the hospital, the objects of interest may move around. That may be to a different aisle or room in the warehouse, a different room (or even a different floor) of the hospital, or different part of the cargo container of the truck. In the latter case, the cargo may have shifted during transit or may have been repositioned as different packages were delivered to different locations. Knowing where the objects of interest are currently located, as opposed to where they are presumed to be based on an initial placement, in addition to other information regarding trips, routes, stops, etc. is a valuable piece of information for an office manager, warehouse manager, nurse or orderly to have. Ideally, such people should be able to get the current location, status, alerts, trip details of a given object or asset on their client computing device such as a laptop, mobile phone or smartwatch.

FIG. 1B is a functional diagram of a tracking system 100. The tracking system 100 may include a plurality of tracking devices, such as tracking tags 102 and 104, and a reader device 106. As discussed further below, one or more server computing devices 108 may also be part of the tracking system 100. A given tracking tag may be placed on or otherwise attached to or inserted into an object to be tracked, such as a package, a piece of equipment, a vehicle, a warehouse section, a room, etc. While tracking tags 102 may be associated with assets or objects such as packages, equipment or vehicles (e.g., a forklift or an autonomous fulfillment robot that can retrieve packages from different locations in a warehouse, items or assets being shipped to various destinations throughout the supply chain), tracking tags 104 may be fixed to an aisle in a warehouse or from a specific room in a hospital. Thus, different tracking tags may be used depending upon user needs. As an example, different users may have varying accuracy and “liveliness” needs. For instance, one user may only want to know aisle-level accuracy every day (e.g., before a warehouse closes for the evening), while another user such as a hospital nurse may need to know which room a piece of equipment is in every hour so that it can be accessed should a patient need such equipment. Each tracking tag 102 or 104 may emit an informational signal, for example a beacon signal, via an antenna, such as using the transmitting device, to communicate data. In this regard, each tracking tag may include an identifier chip (such as for radiofrequency (RF) identification) and/or a transmitting device (such as an RF module configured to transmit beacon signals using a selected frequency band and transmission protocol). In this regard, the beacon signals may simply transmit identifying information in order to enable tracking of objects in the case of tracking tags discussed further below. To facilitate this, each tracking tag may be embedded with a unique identifier, such as a unique MAC address or BLUETOOTH identifier, which may function as a tracking tag identifier. This tracking tag identifier may be assigned to the tracking tag during the manufacturing or provisioning processes (described further below).

The transmitting device may send such information via radio frequency transmission in a selected frequency band, using a standard or proprietary protocol. By way of example, the transmitting device may employ a BLUETOOTH (e.g., a BLUETOOTH Low Energy (BLE)) or 802.11 protocol in the 2.4 GHz and/or 5 GHz frequency bands. In some examples, each beacon tracking tag and each tracking tag uses the BLUETOOTH or BLE protocol.

In some instances, the tracking tags may include one or more sensors. In such instances, the aforementioned communicated data may be formatted according to the selected protocol and include one or more sensed characteristics of the given tracking tag or its environment. For example, the sensed characteristic may be a temperature, motion, light, pressure, location, object details, battery conditions, trip conditions, signal strength and/or other detectable characteristics of the tracking device tracked object or their environment

The reader device 106 may be a computing device configured to detect the beacon signals emitted by the plurality of tracking tags 102 and 104, then store and/or transmit data related to the tracking tags. While only one reader is shown in FIG. 1B, the system may employ multiple readers. The reader device 106 may include one or more processors 110, memory 112 and other components typically present in general purpose computing devices. The reader device 106 includes a receive module 118 having an antenna and a processing section (not shown), which may include a bandpass filter for the frequency band of interest, an analog to digital (A/D) converter, and a signal processing module to evaluate information in received beacon signals. The processing section may also convert the received beacon signal to a baseband signal, before or after A/D conversion. As an example, the reader device may be a fixed device (e.g., mounted on a wall or ceiling and line powered) or may be a mobile device (e.g., a mobile phone, tablet, hand-held scanner, or other device). In some instances, the reader device may additionally act as a tracking tag, such as tracking tags 102 and 104. The reader device may be attached to an assets and record information (e.g., telemetry, temperature, pressure, location information, timing, etc.) associated with the asset. In this regard, the reader device may be configured to collect information included in a beacon or payload otherwise received from a tracking tag.

The one or more processors 110 may be any conventional processors, such as commercially available central processing units (CPUs) or microcontrollers. Alternatively, the one or more processors may be a dedicated device such as an ASIC or other hardware-based processor, such as a field programmable gate array (FPGA). Although FIG. 1B functionally illustrates the processor(s), memory, and other elements of the reader device 106 as being within the same block, the processor, computing device, or memory may actually include multiple processors, computing devices, or memories that may or may not be stored within the same physical housing. For example, memory may be a hard drive, a removable USB drive or other storage media located in a housing different from that of the reader device 106. Indeed, memory may be any non-transitory computer-readable medium that can store computer-executable instructions. Accordingly, references to a processor or computing device will be understood to include references to a collection of processors or computing devices or memories that may or may not operate in parallel.

Moreover, reference to “one or more processors” herein includes situations where a set of processors may be configured to perform one or more operations. Any combination of such a set of processors may perform individual operations or a group of operations. This may include two or more CPUs, graphical processing units (GPUs) and/or tensor processing units (TPUs) (or other hardware-based processors) or any combination thereof. It may also include situations where the processors have multiple processing cores. Therefore, reference to “one or more processors” does not require that all processors (or cores) in the set must each perform all of the operations. Rather, unless expressly stated, any one of the one or more processors (or cores) may perform different operations when a set of operations is indicated, and different processors (or cores) may perform specific operations, either sequentially or in parallel.

The memory 112 stores information accessible by the one or more processors 110, including instructions 114 and data 116 that may be executed or otherwise used by the processor(s) 110. The data may include sensed characteristics from any of the tracking tags 102 and/or 104 received by the reader device 106. The memory 112 may be of any type capable of storing information accessible by the processor(s), including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The data 116 may be retrieved, stored or modified by processor(s) 110 in accordance with the instructions 114. For instance, although the claimed subject matter is not limited by any particular data structure, the data may be stored in computing device registers, in a relational database as a table having a plurality of different fields and records, XML documents or flat files. The data may also be formatted in any computing device-readable format.

The instructions 114 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

In some implementations, the tracking system 100 may further include a central server, such as one or more server computing devices 108 accessible by the one or more processors 110 of the reader device 106. In some implementations, one or more tracking devices in the tracking system 100, such as a tracking tag 104, may be configured to obtain and communicate data (e.g., payloads) directly to the one or more server computing devices 108. The one or more server computing devices 108 may include one or more processors 120, memory 122 and other components typically present in general purpose computing devices. The one or more processors 120 may be the same or similar type as the one or more processors 110, and the memory 122 may be the same or similar type as the memory 112. The memory 122 stores information accessible by the one or more processors 120, including instructions 124 and data 126 that may be executed or otherwise used by the processor(s) 120. Data 126 and instructions 124 may be the same or similar type as the data 116 and instructions 114, respectively.

After detecting the beacon signals of one or more tracking tags 102 or 104, the reader device 106 may transmit the data from the tracking tags to the one or more server computing devices 108 through an existing connection or through a network. Thus, in this case the reader device 106 may include a transmitter module (not shown) that is configured for wired or wireless transmission to the server computing devices. The data may be received in a series of payloads (e.g., data packets) either continually, at one or more set intervals, or ad hoc whenever the tracking tags transmit. Thus, when there are multiple tracking tags, the data is effectively received as a plurality of separate data streams. A given payload (which may include one or more data packets) may include measurements taken at one or more time intervals, each of which may have a corresponding timestamp. In one scenario, the reader device 106 may include a transceiver including both a receiver and a transmitter, which is configured to receive beacon signals from the tracking tags 102 and 104 and also to send and receive information with the one or more server computing devices 108. As discussed in more detail below, the one or more server computing devices 108 may be configured to track characteristics of the tracking devices to determine one or more predictions regarding tracked assets (items including tracking tags 102, 104). The one or more predictions may be determined using one or more software systems.

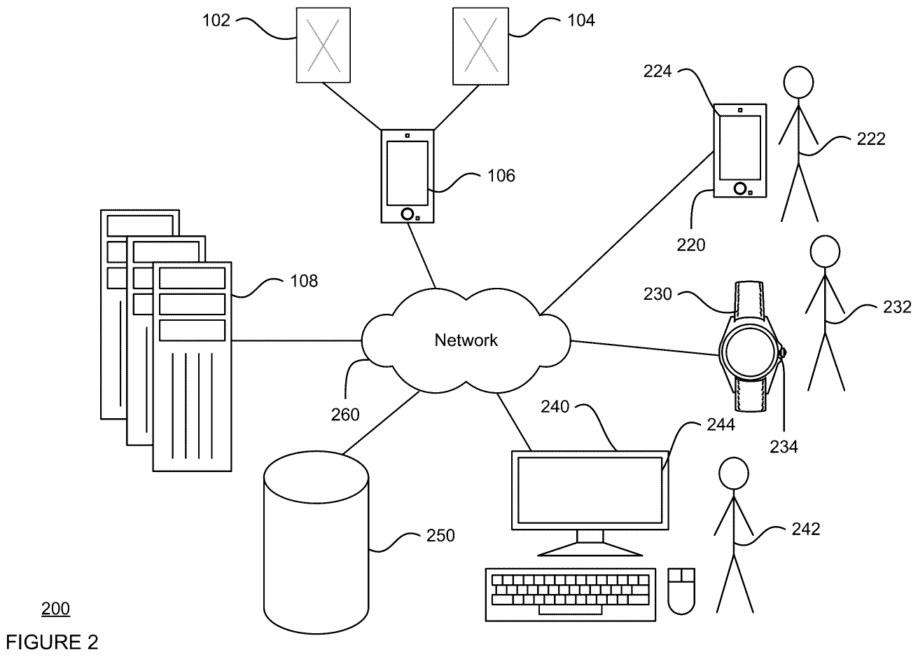

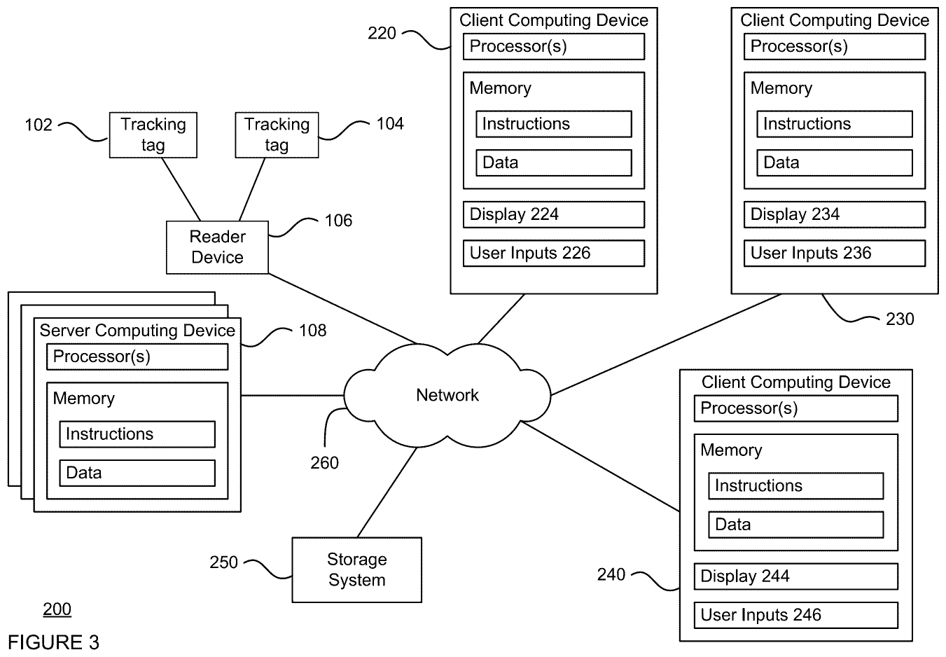

FIGS. 2 and 3 are pictorial and functional diagrams, respectively, of an example system 200 that includes a plurality of client computing devices 220, 230, 240 and a storage system 250 connected via a network 260. System 200 also includes tracking system 100, including tracking tags 102, 104, reader device 106, and server computing devices 108. Although only a few tags and computing devices are depicted for simplicity, a typical system may include significantly more.

Using the client computing devices, users, such as user 222, 232, 242, may view the location data on a display, such as displays 224, 234, 244 of respective client computing devices 220, 230, 240. As shown in FIG. 3, each client computing device 220, 230, 240 may be a personal computing device intended for use by a respective user and have all of the components normally used in connection with a personal computing device including a one or more processors (e.g., a CPU), memory (e.g., RAM and internal hard drives) storing data and instructions, a display such as displays 224, 234, 244 (e.g., a monitor having a screen, a touch-screen, a head-mounted display, a smartwatch display, a projector, a television, or other device that is operable to display information), and user input devices 226, 236, 246 (e.g., one or more of a mouse, keyboard, touch screen and/or a microphone). The client computing devices may also include speakers, a network interface device, and all of the components used for connecting these elements to one another.

Although the client computing devices 220, 230, and 240 may each comprise a full-sized personal computing device, they may alternatively comprise mobile computing devices capable of wirelessly exchanging data with a server over a network such as the Internet. By way of example only, client computing device 220 may be a mobile phone or a device such as a wireless-enabled PDA, a tablet PC, a wearable computing device or system (e.g., a smartwatch or head-mounted display, or a netbook that is capable of obtaining information via the Internet or other networks. As an example, the user may input information using a small keyboard, a keypad, microphone, using visual signals (gestures) with a camera or other sensor, or a touch screen.

The client computing devices may enable a user to receive and view the various events. In some instances, a user may use a web browser to receive and view the various events discussed herein. For example, using the web browser, the client computing devices may access data from the reader device 106 and/or the one or more server computing devices 108 via the network 260. In other instances, a dedicated tracking application may be installed on one or more client computing devices. The application may enable a user of the client computing device to receive and view the various events discussed herein. For example, using the application, the client computing devices may access the data from the reader device 106 and/or the one or more server computing devices 108 via the network 260.

As with memory 112, storage system 250 can be of any type of computerized storage capable of storing information accessible by the one or more server computing devices 108, such as a hard-drive, memory card, ROM, RAM, DVD, CD-ROM, write-capable, and read-only memories. In addition, storage system 250 may include a distributed storage system where data is stored on a plurality of different storage devices which may be physically located at the same or different geographic locations. Storage system 250 may be connected to the computing devices via the network 260 as shown in FIG. 2, and/or may be directly connected to or incorporated into any of the client computing devices 220, 230, 240. The storage system 250 may store information about the tracking tags including, for example, location, status (e.g., activated and when), identifiers, last update, sensed characteristics (e.g., temperature, motion, light, pressure, location, object details, battery conditions, trip conditions, signal strength signal strength and/or other detectable characteristics of the tracking device tracked object or their environment), information about the object to which the tracking tag is attached (e.g., manufacturing data), and so on. In this regard, the information may be determined from received beacon signals provided to and updated at the storage system 250 by any of the one or more server computing devices 108 and/or client computing devices 220, 230, 240.

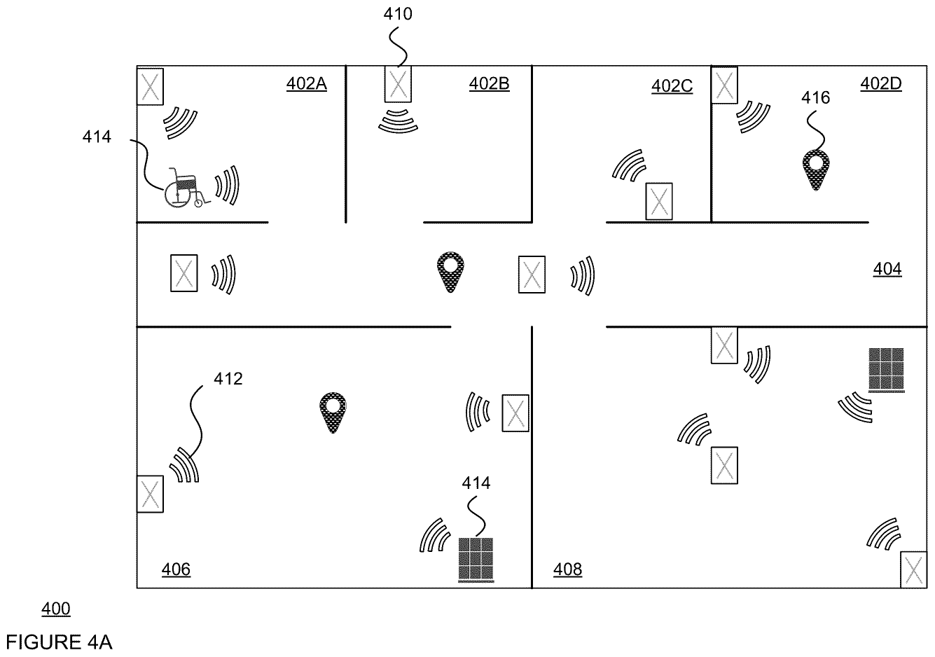

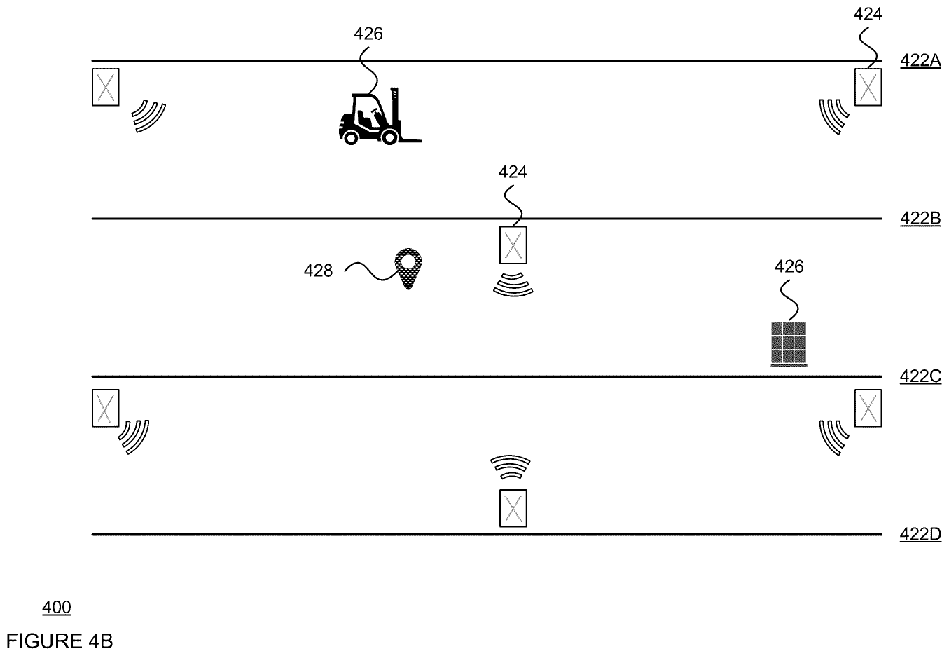

FIG. 4A illustrates one example 400 of a system having a number of tracking tags arranged in various locations of a building (e.g., a hospital). In this example, there may be a number of rooms 402A, 402B, 402C, 402D, such as patient rooms, along one side of a hallway 404. On the opposite side of the hallway 404 there is a storage room 406, such as to house equipment or supplies, as well as another room 408, which may be a meeting room, common area, rehab facility or the like. One or more fixed tracking tags 410 (e.g., line-powered) corresponding to the tracking tags 102 or 104 may be located in each room, including the hallway. Each fixed tracking tag 410 is configured to emit beacon signals 412 (e.g., RF signals in a selected frequency band according to a particular communication protocol). While the beacon signals 412 may appear directional, this need not be the case and the beacon signals may be transmitted omnidirectionally, for instance from a tracking tag 410 that is located on the ceiling, pillar or floor. In some implementations, the tracking tag 410 may be configured to emit beacon signals with the aforementioned sensed characteristics.

Tracking tags 414 may correspond to tracking tags 102 or 104 when placed on a variety of objects (e.g., a case of supplies as shown in storage room 406 or a wheelchair shown in room 402A). In some instances, the tracking tags may also be configured to emit beacon signals with sensed characteristics including information about conditions of the tracking tag or information associated with the object on which the tracking tag is applied (e.g., temperature, motion, light, pressure, location, object details, battery conditions, trip conditions, signal strength and/or other detectable characteristics of the tracking device, tracked object or their environment). Readers 416 may be found at various locations in the building, such as in a patient room, the storage room, the hallway or other location. Note that even if transmitted omnidirectionally, the beacon signals from a given tracking tag may be attenuated in a non-uniform manner due to the presence of walls, furniture, floors/ceilings, equipment, etc.

FIG. 4B illustrates another example 420 of a system having a number of fixed tracking tags positioned along different aisles in a warehouse setting. In this example, there are a number of aisles 422A, 422B, 422C, 422D, although there may be more (or fewer) aisles, and the aisles may be arranged in other configurations than what is shown. Here, fixed tracking tags 424 are located at different places for the aisles, such as along aisle end caps, along the ceiling (or floor), on shelves, storage lockers, cabinets or other places along the aisle, etc. Similar to FIG. 4A, fixed tracking tags 426 are placed on or otherwise associated with different objects, such as a pallet of equipment or a forklift that retrieves items from their locations in the warehouse. As above, the fixed tracking tags are configured to transmit beacon signals that are detectable by one or more reader devices 428 (e.g., line or battery powered).

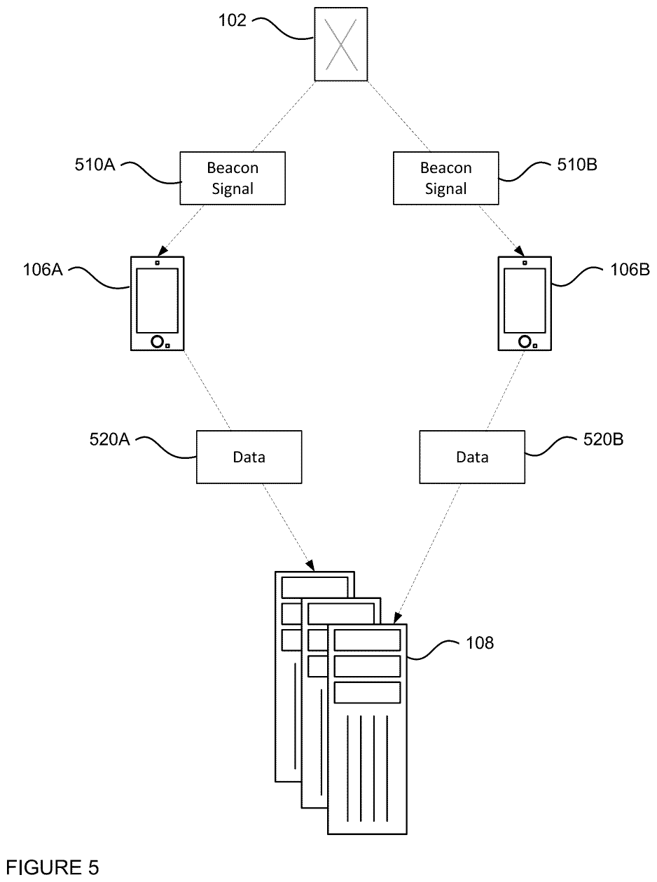

For example, referring to FIG. 5, tracking tag 102 may transmit beacon signals 510A, 510B which may be received by reader devices 106A, 106B (which may be configured the same or similarly to reader device 106). Each reader device in turn may transmit data 520A, 520B (e.g., payloads) to the one or more server computing devices 108. As noted above, this data may provide information about the beacon signals 510A, 510B received from the tracking tag 102. Such information may include tracking tag identifiers, state information (e.g., whether or not the tracking tag has moved or is moving, sensor data or measurements, whether one or more thresholds have been met, etc.), etc. Thus, in this example, each of the reader devices 106A, 106B is within range of the tracking tag 102.

To process data (e.g., payloads), the server computing devices may implement software systems including various modules, queues, tables, etc. The software systems may be stored in the memory of the server computing devices and/or the storage system 250. As discussed further below, these systems may be used to process data such as payloads, interact with various systems including client facing systems, and make predictions regarding tracked assets.

### Model Overview

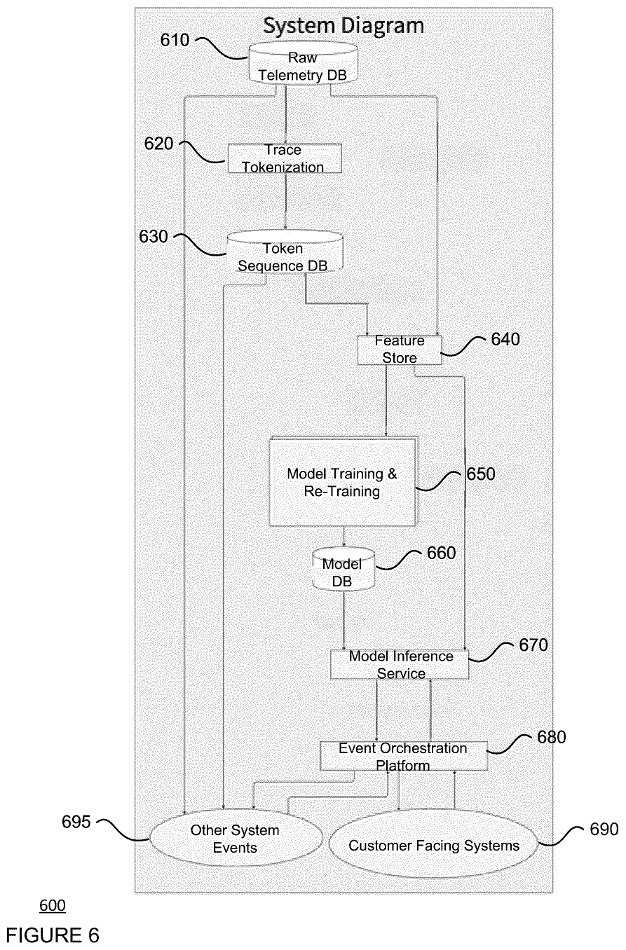

FIG. 6 depicts an example system diagram 600 of an example software system configured to process data (e.g., payloads) and make one or more predictions regarding tracked assets. The example software system includes a raw telemetry database 610, a trace tokenization module 620, a token sequence database 630, a feature store 640, a model training and re-training module 650, a model database 660, a model inference service 670, an event orchestration platform 680, customer facing system 690, and other system events module 695.

The raw telemetry database 610 may be configured to receive raw telemetry or data from various devices. The raw telemetry database 610 may be stored in a memory of one or more server computing devices (e.g., one or more server computing devices 108) and/or a storage system (e.g., storage system 250). The devices may be one or more reader devices (e.g., reader device 106, reader devices 106A, 106B, one or more reader devices 428). The data may be data (e.g., signal strength, timing, identification, environmental information, location information, etc.) from payloads received by the reader devices from one or more tracking tags as discussed above. In this regard, the one or more tracking tags may be affixed to one or more assets to be tracked by the asset tracking system. Additionally, the data may pertain to a status of the one or more assets during trips. A given trip may involve the collective movement of a set of assets from a point of origin to one or more final destinations. In one example, the point of origin may be a first location and the one or more final destinations may be one or more second locations. Additionally or alternatively, the point of origin may be a first zone at a location (e.g., a zone within a building) and the one or more final destinations may be one or more second zones. In another example, a given trip may include transitions from one asset state to another. In this regard the point of origin may be a first state and the one or more final destinations may be one or more second states. The states may include, for example, a threshold number of assets may be at a particular location or zone, a condition of the asset (e.g., temperature), etc.

The trace tokenization module 620 may be configured to process the raw telemetry or data from the raw telemetry database 610. In this regard, the trace tokenization module 620 may be configured to process the raw telemetry or data from the raw telemetry database 610 into sequences of tokens. In this regard, the data may be made easier to process by portions of the system by discretizing it into Boolean semantic statements. This processing may allow noisy data to be converted into cleaner estimates for processing. An example conversion from raw data to a Boolean semantic statement may be temperature=7.89342C to TempIsLessThan10C). In this example, the initial raw data includes a temperature reading in degrees Celsius. The processed Boolean semantic statement includes a statement regarding the temperature with respect to a threshold. In this regard, the statement communicates that the temperature is less than 10 degrees Celsius. Such statements of tokens may be indicative of states that are more meaningful to an end user. Continuing on the above example, if a tracked asset needs to be kept at a particular temperature (e.g., a vaccine), a more meaningful data point may include that the temperature is less than a critical value (e.g., 10 C). This may apply to other more complex Boolean semantic statements such as “AssetisNotWarming”, which communicates that the asset is not increasing in temperature. Such a statement may be similarly valuable regarding, for example, temperature sensitive assets.

The conversion via tokenization may be done by various methods such as, for example, heuristic methodologies. In one example, these heuristics may include grouping and averaging data within time intervals or buckets. The time interval may be, for example, a fixed interval of 30 minutes or more or less. The bucket may be, for example, a collection of a predetermined number of data points. In this regard, each bucket may include a number of data points dependent on the model. In another example the bucket may be, for example, based on space. In this regard, the data may be bucketed based on location (e.g., latitude and longitude coordinates in a particular zone). In some instances, the time intervals or buckets may be a function of the availability and/or volume of the data. The tokenization may allow for use of the processed data in various types of machine learning (ML) models (e.g., RNNs, Transformers, and Generative models like skip-grams and Auto-regressive sequence models; LLM-type models, etc.). In this regard, different models may use the same token sequences therein. As such, new token sequences may not need to be recomputed for different use cases and/or models. The compatibility of the processed data with various ML models may assist in scaling.

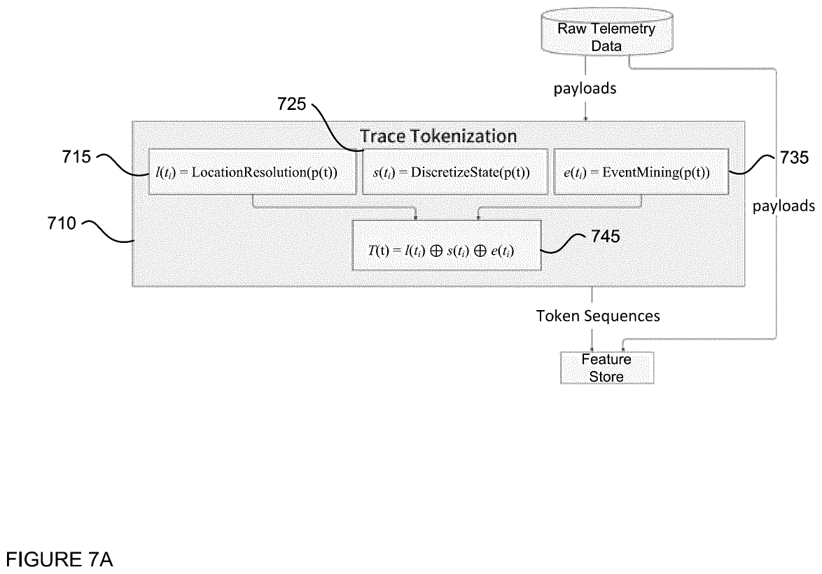

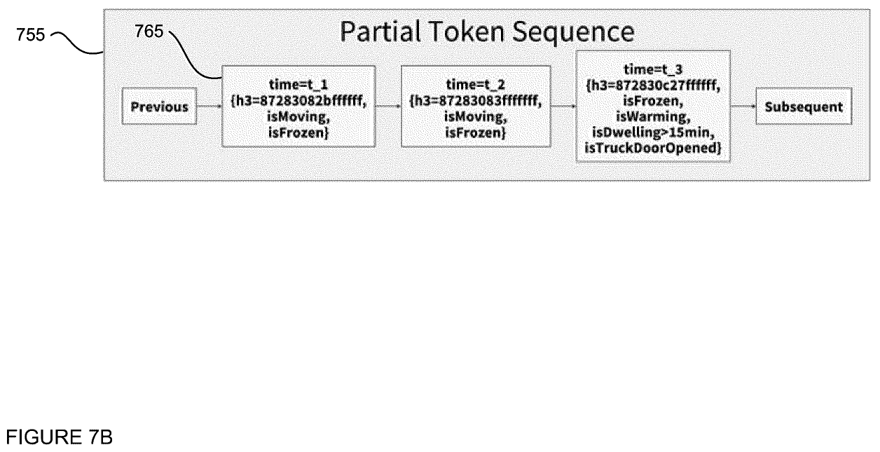

FIG. 7A illustrates an example configuration of subsystems of the trace tokenization module 710 configured to implement heuristic methodologies. The subsystems of the trace tokenization module 710 includes a location resolution subsystem 715, a sensor state discretization subsystem 725, an event mining subsystem 735 and concatenation subsystem 745. The subsystems of the trace tokenization module 710 described herein are merely meant as examples. In this regard, a trace tokenization module may include different subsystems based on the purpose of the system.

The location resolution subsystem 715 may be configured to process raw telemetry or data associated with location (e.g., GPS data, WiFi data, Raw Cell-based location data, Geolocation API data, etc.) and generate processed data. The processed data may include a first plurality of tokens including a first type of information. The raw telemetry or data associated with location may be grouped into time intervals or buckets and the data in each time interval or bucket may be averaged. In some instances, the data may be first grouped and averaged by source, (e.g., GPS, WiFi, Raw Cell-based, Geolocation API, etc.). In such an instance, the averaged data from each source may be grouped into time intervals or buckets and the data in each interval or bucket may be averaged. In some instances, the location resolution system 715 may map the averaged data to H3 indices at one or more resolutions. H3 mapping may include mapping the averaged data to hexagonal cells, each hexagonal cell may correspond to a location. The one or more resolutions may correspond to the area of the hexagonal cells. Hexagonal cells with smaller areas may allow for greater resolution. In some instances, the hexagonal cells may correspond to latitude and longitude coordinates. In some instances, as an alternative to averaging the buckets, more sophisticated logic may be applied to each time interval or bucket. For example, one or more supervised or weakly-supervised models may be applied to arrive at an estimate for each bucket. As a result of the processing of raw telemetry or data associated with location, the location resolution subsystem 715 may generate the first plurality of tokens. The first plurality of tokens may include location information.

The sensor state discretization subsystem 725 may be configured to process raw telemetry or data associated with one or more sensor measurements (e.g., direct pressure, temperature, light, accelerometer measurement, etc.) and generate processed data. The processed data may include a second plurality of tokens including a second type of information. The raw telemetry or data associated with one or more sensor measurements may be processed based on the measurement type. In this regard, the raw telemetry or data of each measurement type may be grouped into different time intervals or buckets and a state associated with each time interval or bucket may be determined. In some instances, a state may be a Boolean semantic statement (e.g., temperature=7.89342C becomes: TempIsLessThan10C). Additionally, or alternatively, a state may be a label regarding the behavior of the data (e.g., the device is not moving, rapidly warming, and likely in direct sunlight, null). The raw data telemetry or data associated with one or more sensor measurements may be processed separately based on measurement type (e.g., direct pressure, temperature, light, accelerometer measurement, etc.). Additionally or alternatively, telemetry or data associated with one or more sensor measurements may be processed with differing measurement types. In this regard, the raw telemetry or data of all measurement types may be grouped into different time intervals or buckets and a state associated with each time interval or bucket may be determined. As a result of the processing of raw telemetry or data associated with one or more sensor measurements, the sensor state discretization subsystem 725 may generate the second plurality of tokens. The second plurality of tokens may include the one or more of Boolean semantic statements and/or the one or more labels regarding the behavior of the data.

The event mining subsystem 735 may be configured to process raw telemetry or data to determine if a specialized event is occurring and generate processed data. The processed data may include a third plurality of tokens including a third type of information. The specialized events may include assets being frozen, opening of an asset, null, etc. The event mining subsystem 735 may be configured to group raw telemetry or data into time intervals or buckets and determine if a specialized event is occurring based on the grouped data. The data in each time interval or bucket may be averaged. In one example, the grouping and averaging by the event mining subsystem 735 may illustrate an asset is below a freezing point over one or more time intervals or buckets. Based on this, the event mining subsystem 735 may determine the asset is frozen. This may result in the event mining subsystem 735 generating a frozen label for the one or more time intervals or buckets. In some instances, as an alternative to averaging the buckets, more sophisticated logic may be applied to each time interval or bucket. For example, one or more supervised or weakly-supervised models may be applied to arrive at an estimate for each bucket. As a result of the processing of raw telemetry or data for specialized events, the event mining subsystem 735 may generate the third plurality of tokens. The third plurality of tokens may include the one or more of the labels associated with the determined specialized events.

The concatenation subsystem 745 may be configured to concatenate or direct-sum the processed data included in the tokens generated by the location resolution subsystem 715, the sensor state discretization subsystem 725, and the event mining subsystem 735 into a token sequence. In this regard, the concatenation subsystem 745 may be configured to concatenate the first plurality of tokens, the second plurality of tokens, and the third plurality of tokens into a token sequence such that the concatenated token sequence includes information of each plurality of token sets. In this regard, one token of the concatenated token sequence may include the first type of information, the second type of information, and the third type of information. FIG. 7B illustrates an example partial token sequence 755 generated by the concatenation subsystem 745. Each token of the partial token sequence 755 may be a token associated with a different time or time interval or bucket. Token 765 illustrates an example token at a first time, time interval, or bucket t_1. Token 765 includes a hexadecimal index corresponding to location (h3=87283082bfffffff), a label corresponding to one or more sensor measurements (e.g., “isMoving”) and a label corresponding to a specialized event (e.g., “isFrozen”).

In some instances, the trace tokenization module 710 may be configured to generate additional token sequences as additional raw telemetry is received. In this regard, the additional token sequences may include tokens associated with time intervals or buckets occurring subsequent to the time intervals or buckets of the tokens of the previously generated token sequences. Alternatively, additional token sequences may include both tokens associated with time intervals or buckets occurring subsequent to the time intervals buckets of the tokens of the previously generated token sequences and tokens associated with the time intervals or buckets of the previously generated token sequences.

In some instances, at least one of the generated one or more token sequences from the trace tokenization module 620 may be associated with a tracking tag (e.g., tracking tags 102 and 104) which the tracking tag is tracking a singular asset within the system. In this regard, the at least one of the one or more generated token sequences may include information regarding the singular tracked asset.

Additionally or alternatively, at least one of the generated one or more token sequences from the trace tokenization module 620 may be associated with a plurality of tracking tags (e.g., tracking tags 102 and 104) each associated with a different asset within the system. In this regard, the at least one of the one or more generated token sequences, may include information regarding the plurality of tracked assets.

Additionally or alternatively, at least one of the generated one or more token sequences from the trace tokenization module 620 may be associated which a tracking tags (e.g., tracking tags 102 and 104) associated with a plurality of asset within the system (e.g., a tag positioned in a room or truck containing a plurality of assets). In this regard, the at least one of the one or more generated token sequences, may include information regarding the plurality of tracked assets.

The generated token sequences from the trace tokenization module 620 may be stored in the token sequence database 630. The feature store 640 may be configured to receive generated token sequences from the trace tokenization module 620 and data from the raw telemetry database 610. The feature store may be further configured to provide received, generated token sequences from the trace tokenization module 620 and/or data from the raw telemetry database 610 to the model inference service 670 for by one or more ML models in the determination of predictions.

The feature store 640 may be further configured to generate one or more training data sets using the token sequences from the token sequence database 630 and/or data from the raw telemetry database 610. The feature store 640 may be configured to generate additional training data sets as additional raw telemetry or data is stored in the raw telemetry database 610 and additional token sequences are generated.

The feature store 640 may generate the one or more training data sets including different features and example situations (data types, inference types, etc.). In some instances, the one or more training data sets may be specific to a model to be trained based on the included features and example situations. Additionally or alternatively, the one or more training data sets may be specific to a user based on the user's system.

In some instances, the training data may include raw telemetry or data that has not been processed into token sequences. Certain models may be configured to input raw telemetry or data in addition to or as an alternative to token sequences. For example, models configured to provide labels to data as part of all of a generated prediction may use raw telemetry or data as an input. In this regard, the training data of such a model may similarly include raw telemetry or data.

The feature store 640 may be further configured to provide the generated one or more training data sets to the model training and re-training module 650. The model and retraining module 650 may be configured to train one or more ML models stored in the model database 660 using the generated one or more data sets from the feature store 640. The model and retraining module 650 may be further configured to re-train models stored in the model database 660 upon reception of additional raw telemetry or data by the system and generation of additional token sequences. In some instances, the training may be weak supervision or semi-supervised learning. In this regard, the generated training data used to train and retrain the one or more ML models may include minimally labeled data

In some instances, the model and retraining module 650 may utilize semantic versioning. In this regard, training and re-training of the one or more ML models generates additional versions of an ML model of the one or more ML models. For example, an ML model stored in the model database 660 may be a first version. Upon training of the first version of the ML model by the model and retraining module 650, a second version of the ML model may be generated and stored in the model database 660. Furthermore, upon re-training of the first version and/or second version of the ML model using additional training data, a third version of the ML model may be generated and stored in the model database 660. In such an example, one of the versions of the ML model may be a primary model. The primary model may be the model used in making client facing predictions.

The model inference service (MIS) 670 may provide a layer of abstraction that allows for calls to request predictions made by the one or more ML models. In this regard, the MIS 670 may be implemented as a module of the system that provides an interface between the one or more ML models and the customer facing systems 690. The MIS 670 may include a separate application programming interface (API) for each prediction or inference a model performs. The MIS 670 may be configured to receive calls or requests for predictions from the one or more ML models. The MIS 670 may then fetch the one or more ML models associated with the prediction stored in the model database 660. The one or more models may include multiple versions of ML models (e.g., first version, second version, third version as discussed above). The MIS 670 may then receive predictions from the one or more ML models. In some instances, the predictions may include predictions from multiple variants of an ML model of the one or more ML models. In such an instance, the MIS 670 may be configured to communicate the prediction from a primary model of the variants in response to the call.

In some instances, the MIS 670 may be configured to validate the call. If the call is validated the MIS 670 may proceed to fetch the one or more ML models and provide a prediction to the caller. If the call is not validated, the MIS 670 may not fetch the one or more ML models. The call can be validated based on various criteria. In one example, the validation may be based on an identification of the call. In this regard, a call with an identification that does not have permission to make such a call (e.g., to a particular model or regarding a particular device or asset) may not be validated and thus may return a not valid result to the caller.

In another example, the validation may be based on the freshness of the call. The freshness of the call may be related to the ability of the system to generate a prediction at the time it is made. In an example where the call is for an estimated time of arrival (ETA) prediction of an asset, the call may not be fresh if the asset is currently not on a trip. Such a call may not be validated and thus may return a not valid result to the caller.

In a further example, the validation may be based on a rate limit. In some instances, the rate limit may be specific to a model of the one or more ML models. In this regard, a call may be considered invalid if too many calls for a particular asset or device are sent. The rate limit may be for example one call per device per minute or more or less. If a call exceeds the rate limit, such a call may not be validated and thus may return a not valid result to the caller. Alternatively, the MIS 670 may be configured to return a previously cached prediction and not fetch the one or more ML models to generate a new predication. In one example, the rate limit may be selected such that the cached prediction has a low likelihood of having changed. In this regard, the rate limit may correspond to the frequency of the receipt of data or payloads. In this regard, the prediction has a low likelihood of change when the system has not received new data on which to base the predictions.

In another example, the MIS 670 may fetch a model of the one or more ML models configured to make a determination regarding returning a cached prediction. For instance, the model may determine a likelihood that a cached prediction will change based on data received since the cached prediction was generated. The model may be trained based on generated predictions from the one or more ML models. Predictions from an ETA model may be used to train an ETA caching model. The ETA caching model may be configured to parse what changes in received are likely to cause smaller or larger changes in a predicted ETA and generate a likelihood thereof. In this regard, the ETA caching model may control caching behavior based on the generated likelihood.

The event orchestration platform 680 may be configured to call to the MIS 670 for prediction requests. A call to the MIS 670 from the event orchestration platform 680 may be prompted when an event occurs. Events may be an indicator that something interesting has happened within the system (e.g., a payload is received, a trip has started or arrived, a transition of assets between couriers, etc.). An event occurrence may be received by the event orchestration platform 680 from the other system events module 695 and/or from the MIS 670 after a prediction is made.

In this regard, the other system events module 695 may receive a notification from the raw telemetry database 610 of receipt of a payload. The notification may be sent as an event occurrence to the event orchestration platform 680 and may trigger a call to the MIS 670. Additionally, the other system events module 695 may receive a notification from the token sequence database 630 when a new token sequence is stored therein and/or if a the newly stored token sequence is indicative of an event occurrence (e.g., a trip has started or arrived, a transition of assets between couriers, etc.). The notification may be sent as an event occurrence to the event orchestration platform 680 and may trigger a call to the MIS 670.

Additionally or alternatively, the one or more ML models may make a prediction corresponding to an event occurrence based on a prior call thereto. The prediction of the event occurrence may be sent to the event orchestration platform 680 by the MIS 670. The event orchestration platform 680 may then send an additional call to the MIS 670 based on the prediction corresponding to the event occurrence. For example, the receipt of device payload may trigger a call for a first prediction. The first prediction may be a trip inference prediction. The trip inference prediction may be indicative of the start of a trip. The trip inference prediction may be sent to the event orchestration platform 680 and may trigger a call for a second prediction related to the trip (e.g., estimated time of arrival prediction, anomaly trip prediction, delivery prediction, destination prediction, etc.).

In some instances, a call to the MIS 670 from the event orchestration platform 680 may be prompted in response to a request from a user for a prediction (e.g., from customer facing systems 690). Additionally or alternatively, a call to the MIS 670 from the event orchestration platform 680 may be prompted periodically. In this regard, a call for predictions may be prompted once every interval (e.g., 1 min, 1 hour, or more or less frequently).

Following the receipt of a prediction from the MIS 670, the event orchestration platform 680 may be to interact with the customer facing systems 690. In this regard, the event orchestration platform 680 may be configured to validate customer information (e.g., intended trips, asset and device intended locations, etc.) and/or trigger alerts based on the prediction (e.g., information validation alerts, trip status alerts, trip deviation alerts, etc.). In some instances, the alerts may be messages including suggestions to users of the system. For example, in a hospital environment, the predictions could be converted into suggestions for staff nurses to locate units of different assets in preparation for pre-planned procedures. In this example, the customer facing systems 690 be integrated both upstream of the event orchestration platform 680 (e.g., a calendar of upcoming procedures may be received by the system) and downstream of the event orchestration platform 680 (e.g., the event orchestration platform 680 may be configured to interact with a system that curates daily notes/tasks for hospital staff).

Additionally or alternatively, the event orchestration platform 680 may be configured to trigger an action based on the predictions. For example, the event orchestration platform 680 may interact with a portion of the client facing system configured to order additional supplies. In this regard the event orchestration platform 680 may be configured to trigger ordering of additional stock when the predictions are indicative of low supply. In some instances, an alert may be triggered alongside the ordering. Alternatively, an alert including a suggestion to order additional stock may be triggered.

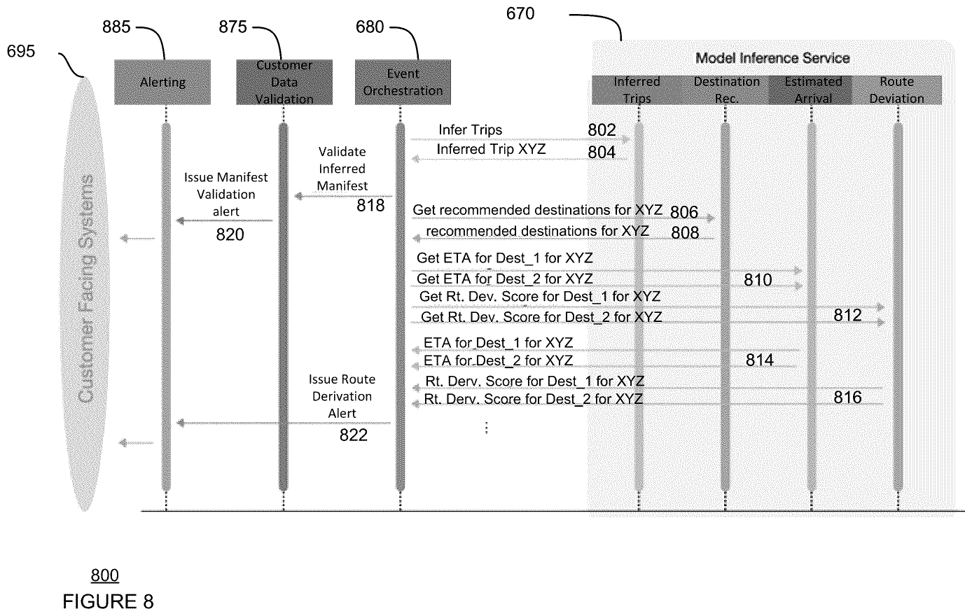

FIG. 8 illustrates an example call tree 800 of the event orchestration platform 680. In an example call tree 800, the event orchestration platform 680 may call the MIS 670 to “infer trips” as shown by arrow 802. The infer trips call may be in response to the receipt of a payload. In response to the infer trips call, the MIS 670 may fetch a trip inference ML model which may make a prediction. The inferred trip prediction may then be sent to the event orchestration platform 680 as shown by arrow 804. The inferred trip prediction may be indicative of the start of one or more events such as one or more trips. Based on the one or more trips indicated by the inferred trip prediction, the event orchestration platform 680 may call to the MIS 670 to “get recommended destinations” for the one or more trips as shown by arrow 806. In response to the infer trips call, the MIS 670 may fetch a destination recommendation ML model which may make a prediction. The destination recommendation prediction may then be sent to the event orchestration platform 680 as shown by arrow 808. The destination recommendation prediction may be indicative of one or more destinations of the one or more trips.

Based on the one or more destinations of the one or more trips indicated by the destination recommendation prediction, the event orchestration platform 680 may call to the MIS 670 to “get estimated time of arrival” for the one or more destinations as shown by arrow 810 and to “get route deviation score” for the one or more destinations as shown by arrow 812. In response to the estimated time of arrival call and the route deviation score call, the MIS 670 may fetch a destination recommendation ML model and a route deviation ML model which may each make a prediction. The predictions may then be sent to the event orchestration platform 680 as shown by arrows 814 and 816 respectively. The estimated time of arrival prediction may be indicative of an estimated time of arrival to the one or more destinations of the one or more trips. The deviation score prediction may be indicative of aberration in a planned route of the one or more trips. The planned route may be an expected route supplied by a user (e.g., specified by a sequence of waypoints or a set of H3 cells) and/or may be based on predictions or observations by the system based on historical data. For example, the historical data may be indicative of multiple trips from position A to position B using a first route and the system predicts the current trip from position A to position B using a second route. The system may further determine and the second route is different from the first route and is indicative of a deviation.

The event orchestration platform 680 may be further configured to interact with other modules of the system. As illustrated by arrow 818, the event orchestration platform 680 may be configured to interact with a customer data validation module 875. The customer data validation module 875 may be configured to validate customer provided data, such as trip destinations, arrival times, route, etc. using predictions from the event orchestration platform 680. Based on the validation, the customer data validation module 875 may communicate with an alerting module 885, as indicated by arrow 820, to send a validation alert to the customer facing systems 695. The alert may be a validating alert if the predictions agree with the customer provided data. The alert may be an invalidating alert if the predictions do not agree with the customer provided data.

Additionally, as illustrated by arrow 822, the event orchestration platform 680 may directly communicate with the alerting module 885 to provide alerts to the customer facing systems 695. The alerts may be based on the predictions. In some instances, the predictions from different models may be combined with other predictions by the event orchestration platform 680 to provide higher level alerts to the customer. For example, if the temperature of an asset is predicted to rise beyond a threshold temperature with high confidence in an hour, but the estimated trip time remaining is greater than an hour, an alert may be sent to a user or customer. However, if the estimated trip time remaining is less than an hour, an alert may not be sent.

In some instances, the event orchestration platform 680 can be programmed to automatically decompose requests that require multiple calls to models into the constituent calls and return the composite result. For example, an inventory optimization model configured to return the best ordering policy for units of some stock keeping unit (SKU) across different warehouses. The model may need to know a forecasted demand for that SKU and supply of that SKU to each warehouse. Thus, the one call (inventory optimization) may cause the event orchestration platform 680 to generate a batch of calls for forecasts at each warehouse before it can feed these results into the inventory optimization model to generate an optimal ordering result.

### Example ML Models of the System

The system described herein may be configured to implement one or more ML models. The ML models may be configured to make predictions regarding assets of a customer. The plurality of ML models may be trained such that customers may only need to affix tracking tags to their assets and set up a reader network. Once this is done the system may function automatically (e.g., no further customer input needed). This functioning may include, but is not limited to: i) detect that a trip is happening, ii) detect if there is anything abnormal about the trip, iii) infer where the trip is going to, iv) provide an ETA for when it will get there, v) predict the physical condition of assets on the trip and/or vi) detect when the trip has ended. Each of these elements may be determined based on predictions of the plurality of ML models. Additionally, as discussed above, the system may be configured to send alerts regarding these elements to the customer. In some instances, the alerts may be messages including suggestions to users of the system. For example, in a hospital environment, the predictions could be converted into suggestions for staff nurses to locate units of different assets in preparation for pre-planned procedures. In this example, the customer facing system be integrated both upstream of the system (e.g., a calendar of upcoming procedures may be received by the system) and downstream of the system (e.g., the event orchestration platform may be configured to interact a system that curates daily notes/tasks for hospital staff). Additionally or alternatively, as discussed above, the system may be configured to take an action based on these elements (e.g., trigger ordering of additional stock when supply is low).

The plurality of ML models may include models such as trip inference, trip anomaly detection, destination recommendation, estimated time of arrival, conditions forecasting, and delivery detection. The trip inference model may be configured to predict if one or more tracked assets are on a trip (e.g., being moved from one location to another, being moved from one indoor zone to another, and/or transitioning from one state to another). The trip inference model may make such a prediction using token sequences generated from raw telemetry or data as discussed above and/or raw telemetry or data. In one instance, the prediction may be based on latitude-longitude traces of the assets. Additionally or alternately, the prediction may be based on geofence conditions (e.g., if a virtual perimeter or location is passed by the assets). Additionally or alternately, may use the location of the assets as described in the generated token sequences and probabilistic modality to compute a likelihood the assets are moving through the same locations.

The trip anomaly model may be configured to make predictions regarding whether a trip underway looks as expected. In this regard, the trip anomaly model may predict if there are any deviations (e.g., with respect to historical trips, planned trip route, etc.). The deviations may be related to, for example, the route, the timing, etc. The trip anomaly model may make such deviation predictions using token sequences generated from raw telemetry data as discussed above and/or raw telemetry or data. For example, the trip anomaly model may make estimates regarding the probability of transitions between tokens (e.g., h3 indices thereof) conditioned on historical trip data or planned trip route data. These estimates may be used to score a given sequence of locations according to a likelihood function. The score can correspond to the predictions regarding whether a trip underway looks as expected.

The destination recommendation model may be configured to make predictions regarding one or more destinations of the assets. The one or more destinations may correspond to locations where the assets may stop during a trip and/or where the trip will end. The destination recommendation model may make such predictions using token sequences generated from raw telemetry data as discussed above and/or raw telemetry or data. For example, the destination recommendation model may determine probabilities of transitions between tokens of the token sequence. Then, the trip anomaly model may forecast the most probable future tokens and values thereof of a sequence. The forecast may correspond to the predictions regarding the one or more destinations. In some instances, the destination recommendation model may use historical trip information in the forecasting.

The estimated time of arrival (ETA) model may be configured to make predictions regarding the ETA of the assets to a destination. The ETA model may make such predictions using token sequences generated from raw telemetry or data as discussed above and/or raw telemetry or data. The ETA model may be configured to account for stops at one or more destinations prior to reaching a subsequent destination. For example, if a vehicle carrying tracked assets stops at a first warehouse prior to arriving at a second warehouse which is the destination of the tracked assets.

The conditions forecasting model may be configured to make predictions regarding the physical conditions of assets themselves. The conditions may be related to one or more of temperature, pressure, humidity, light, acceleration, etc. of the assets. The conditions forecasting model may make such predictions using token sequences generated from raw telemetry or data as discussed above and/or raw telemetry or data. For example, a prediction may be a prediction of temperature of the assets in a future time interval or bucket.

The delivery detection model may be configured to predict or recognize when a delivery of an asset has been made or when an important stop has occurred. The delivery detection model may make such predictions using token sequences generated from raw telemetry or data as discussed above and/or raw telemetry or data. The delivery detection model may make such predictions by training and applying a weak supervision model that may incrementally score events of the token sequences. The score may be indicative of whether a delivery happened. The events may include, for example, a geofence break, condition changes, “seen-by” events, and shipment-based network changes.

The geofence break may include if a virtual perimeter is passed by the assets. The virtual perimeter may be present in both indoor and outdoor systems. For example, in an indoor system the virtual perimeter may include a doorway or any other indoor location within a facility. In another example, in an outdoor system the virtual perimeter may correspond to a location on a map, a radius from a starting position, etc. In some instances, the virtual perimeter may correspond to the delivery destination.

Condition changes may include changes of or based on one or more measurements collected by tracking tags disposed on assets. For example, condition changes may include rapid rises in temperature indicative of opening a refrigerated truck and unloading packages and significant changes in light levels indicative of opening a box when our tracking beacon is inside. In this regard, such condition changes may be indicative of delivery (e.g., a vehicle arriving at a delivery destination). “Seen-by” events may include when one or more readers of a delivery destination receives a payload from the assets in transit. This may be indicative of delivery to the delivery destination.

Shipment based network changes may include when values of a payload change. For example, when a reader device of a delivery vehicle no longer receives payloads from one or more assets in transit, this may be indicative of delivery to a delivery destination. Additionally or alternatively, a sudden change in signal strength may be indicative of delivery to a delivery destination (e.g., due to opening of the door of a vehicle including tracked assets).

The determined scores of events, which may be arranged in chronological order (e.g., time series), may be used to make a prediction regarding whether delivery at a delivery destination has occurred. In this regard, the scores of the events may correspond to a likelihood that delivery has occurred. Certain events carry a higher likelihood that delivery has occurred, thus may include higher scores. For example, a “seen by” event may include a higher score than shipment-based network changes. Once the overall score surpasses a threshold value, the delivery detection model may generate a prediction that a delivery has occurred. In some instances, the time of the delivery prediction may correspond to the time in which the overall score surpasses the threshold value. In some instances, further logic may be applied to determine a delivery time. For example, a mathematical derivative of the score may be taken and the time corresponding to the first peak prior to the overall score surpassing the threshold value may correspond to the delivery time. In another example, a secondary ML mode may be configured to estimate the delivery time. Such a model may be weakly supervised or fully supervised.

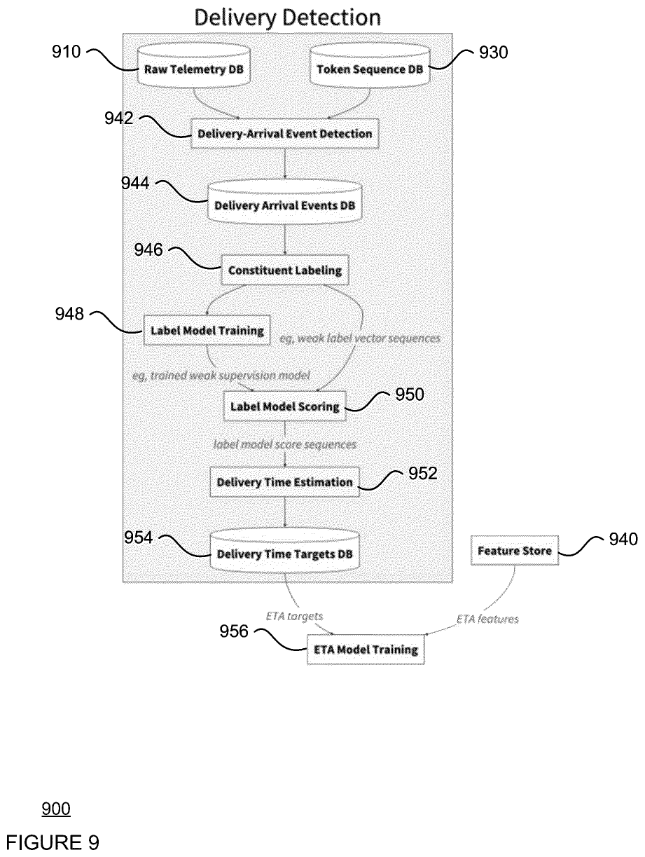

FIG. 9 illustrates an example framework of a delivery detection model 900. The delivery detection model 900 may be configured to identify one or more events (e.g., a geofence break, condition changes, “seen-by” events, and shipment-based network changes) at the delivery-arrival event detection module 942. The delivery-arrival event detection module 942 may be configured to identify such events using raw telemetry of data from the raw telemetry database 910 and generated token sequences from the token sequence database 930. The identified events may be stored in the delivery arrival events database 944. The constituent labeling module 946 may be configured to provide labeled training data relating to the identified events stored in the delivery arrival events database 944. The labeling of the training data may be suited for weak-supervision training. The labeled training data may include label vector sequences. The label vector sequences may be provided to the label model training module 948 while may be configured to train a scoring model of the detection model. The trained scoring model and the label vector sequences may be provided to the label model scoring module 950.

The label model scoring module 950 may be configured to provide scores to the label vector sequences and corresponding events. Based on the provided scores, the delivery time estimation module 952 may be configured to determine a delivery prediction. The delivery prediction may include a time at which a delivery to a delivery destination has occurred. The delivery predictions may be provided to an event orchestration platform as discussed above. Additionally or alternatively, the delivery predictions may be stored in a delivery time target database 954. The delivery time targets database 954 may be configured to provide the delivery predictions as training data in addition to training data from the feature store 940 to one or more other model training modules. As illustrated in FIG. 9, the other model training modules may include an ETA module training module 956.

### Model Training

As discussed above, one or more ML models of an example software system configured to process data may be trained using customer-specific data received by the system (e.g., as payloads). Such training may result in ML models that are customized based on the data (e.g., for a specific customer). Prior to the receipt of such data, the one or more ML models may be trained using non-specific training data. The non-specific training data based on testing data (e.g., data collected specifically for model training), synthetic data (e.g., generated by a model configured to probabilistically generate synthetic trip examples, for example an auto-encoder or GAN), and/or data from other users or customers.

In some instances, the generation of training data may include constructing training datasets by merging featurized and labeled data together in preparation for supervised training. The merging may include merging of the features and labels in conjunction with the data. The generation may further include i) validating the data according to rough quality criteria (e.g., no not include trips that do not progress or ended, that do have sufficient data density/quality to support prediction, etc.) and/or ii) formatting for model consumption (e.g., prepare the data in a manner consumable as in input of the intended model). When generating customer-specific training data, the generation may include filtering data by user (e.g., create data sets specific to a user and only include a specific user's data in each training data set)

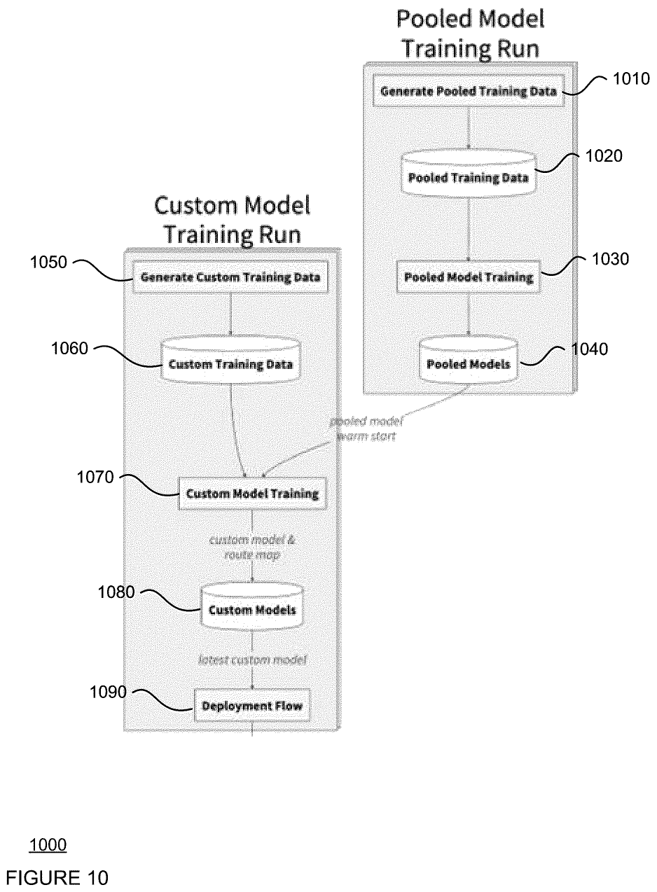

FIG. 10 illustrates an example training framework 1000 using both data received by the system and non-specific data to train one or more ML models. Pooled training data module 1010 may be able to generate training data. The non-specific data may be based on testing data. The non-specific data may be stored in a pooled training data database 1020. The non-specific data stored in the pooled training data database 1020 may be provided to a pooled model training module 1030. The pooled model training module 1030 may be configured to train the one or more ML models of the system using the non-specific data. The trained one or more ML models may be stored in the pooled model database 1040.

The one or more ML models may be further trained using training data generated from payloads received by the system. The payloads may be payloads from tracking tags on assets of a user. In this regard, the training data may be customer-specific and thus result in trained models specific to the user. A custom training data module 1050 may be configured to generate training data based on the payloads received by the system.

The customer-specific data may be stored in a custom training data database 1060. The customer-specific data stored in the custom training data database 1060 may be provided to a custom model training module 1070. The custom model training module 1070 may be configured to train the one or more ML models of the system using the customer-specific data. One or more ML models may be provided to the custom model training module 1070 from the pooled models database 1040. The one or more ML models trained by the custom model training module 1070 may be stored in the custom model database 1080.

In some instances, the pooled custom model training module 1030 and the custom model training module 1070 may utilize semantic versioning. In this regard, training of the one or more ML models generates additional versions of an ML model of the one or more ML models. For example, an ML model stored in a model database 1040, 1080 may be a first version. Upon training of the first version of the ML model, a second version of the ML model may be generated and stored. Furthermore, upon re-training or further training of the first version and/or second version of the ML model using additional training data, a third version of the ML model. In such an example, one of the versions of the ML model may be a primary model. The primary model may be the model used in making client facing predictions.

### Example Methods

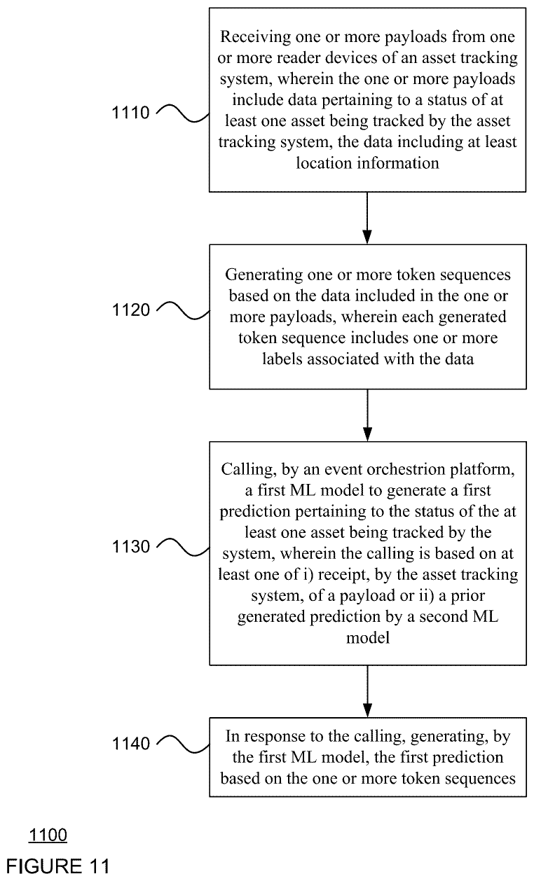

The systems described above may be used in a method of making predictions. FIG. 11 illustrates an example method 1100 of making one or more predictions. At block 1110, the method includes receiving one or more payloads from one or more reader devices of an asset tracking system, wherein the one or more payloads include data pertaining to a status of at least one asset being tracked by the asset tracking system, the data including at least location information. As discussed above, the raw telemetry database 610 may be configured to receive raw telemetry or data from various devices. The raw telemetry database 610 may be stored in a memory of one or more server computing devices (e.g., one or more server computing devices 108) and/or a storage system (e.g., storage system 250). The devices may be one or more reader devices (e.g., reader device 106, reader devices 106A, 106B, one or more reader devices 428).

The data may be data (e.g., signal strength, timing, identification, environmental information, location information, etc.) from payloads received by the reader devices from one or more tracking tags as discussed above. In this regard, the one or more tracking tags may be affixed to one or more assets to be tracked by the asset tracking system. Additionally, the data may pertain to a status of the one or more assets during trips. A given trip may involve the collective movement of a set of assets from a point of origin to one or more final destinations. In one example, the point of origin may be a first location and the one or more final destinations may be one or more second locations.

Additionally or alternatively, the point of origin may be a first zone at a location (e.g., a zone within a building) and the one or more final destinations may be one or more second zones. In another example, a given trip may include transitions from one asset state to another. In this regard the point of origin may be a first state and the one or more final destinations may be one or more second states. The states may include, for example, a threshold number of assets may be at a particular location or zone, a condition of the asset (e.g., temperature), etc.

At block 1120, the method includes generating one or more token sequences based on the data included in the one or more payloads, wherein each generated token sequence includes one or more labels associated with the data. The one or more token sequences may be generated by a trace tokenization module 620, 710 as discussed above.

At block 1130, the method further includes calling, by an event orchestrion platform, a first ML model to generate a first prediction pertaining to the status of the at least one asset being tracked by the system, wherein the calling is based on at least one of i) receipt, by the asset tracking system, of a payload or ii) a prior generated prediction by a second ML model. In this regard, the calling may include, by an event orchestrion platform, a MIS to generate one or more predictions based on one or more events. As discussed above, a call to the MIS 670 from the event orchestration platform 680 may be prompted when an event occurs. Events may be an indicator that something interesting has happened within the system (e.g., a payload is received, a trip has started or arrived, a transition of assets between couriers, etc.). An event occurrence may be received by the event orchestration platform 680 from the other system events module 695 and/or from the MIS 670 after a prediction is made. In this regard, the other system events module 695 may receive a notification from the raw telemetry database 610 of receipt of a payload. The notification may be sent as an event occurrence to the event orchestration platform 680 and may trigger a call to the MIS 670. Additionally, the other system events module 695 may receive a notification from the token sequence database 630 when a new token sequence is stored therein and/or if a the newly stored token sequence is indicative of an event occurrence (e.g., a trip has started or arrived, a transition of assets between couriers, etc.). The notification may be sent as an event occurrence to the event orchestration platform 680 and may trigger a call to the MIS 670.

Additionally or alternatively, the one or more ML models may make a prediction corresponding to an event occurrence based on a prior call thereto. The prediction of the event occurrence may be sent to the event orchestration platform 680 by the MIS 670. The event orchestration platform 680 may then send an additional call to the MIS 670 based on the prediction corresponding to the event occurrence. For example, the receipt of device payload may trigger a call for a first prediction. The first prediction may be a trip inference prediction. The trip inference prediction may be indicative of the start of a trip. The trip inference prediction may be sent to the event orchestration platform 680 and may trigger a call for a second prediction related to the trip (e.g., estimated time of arrival prediction, anomaly trip prediction, delivery prediction, destination prediction, etc.).

In some instances, a call to the MIS 670 from the event orchestration platform 680 may be prompted in response to a request from a user for a prediction (e.g., from customer facing systems 690). Additionally or alternatively, a call to the MIS 670 from the event orchestration platform 680 may be prompted periodically. In this regard, a call for predictions may be prompted once every interval (e.g., 1 min, 1 hour, etc.).

The calling may additionally include fetching by the MIS, one or more ML models configured to generate the one or more predictions. As discussed above, the MIS 670 may be configured to receive calls or requests for predictions from the one or more ML models. The MIS 670 may then fetch the one or more ML models associated with the prediction stored in the model database 660. The one or more models may include multiple versions of ML models (e.g., first version, second version, third version as discussed above).

In some instances, the MIS 670 may be configured to validate the call. If the call is validated the MIS 670 may proceed to fetch the one or more ML models and provide a prediction to the caller. If the call is not validated, the MIS 670 may not fetch the one or more ML models. The call can be validated based on various criteria. In one example, the validation may be based on an identification of the call. In this regard, a call with an identification that does not have permission to make such a call (e.g., to a particular model or regarding a particular device or asset) may not be validated and thus may return a not valid result to the caller.

In another example, the validation may be based on the freshness of the call. The freshness of the call may be related to the ability of the system to generate a prediction at the time it is made. In an example where the call is for an estimated time of arrival (ETA) prediction of an asset, the call may not be fresh if the asset is currently not on a trip. Such a call may not be validated and thus may return a not valid result to the caller.

In a further example, the validation may be based on a rate limit. In this regard, a call may be considered invalid if too many calls for a particular asset or device are sent. In some instances, the rate limit may be specific to a model of the one or more ML models. The rate limit may be for example one call per device per minute or more or less. If a call exceeds the rate limit, such a call may not be validated and thus may return a not valid result to the caller. Alternatively, the MIS 670 may be configured to return a previously cached prediction and not fetch the one or more ML models to generate a new predication. In one example, the rate limit may be selected such that the cached prediction has a low likelihood of having changed. In this regard, the rate limit may correspond to the frequency of the receipt of data or payloads. In this regard, the prediction has a low likelihood of change when the system has not received new data on which to base the predictions.

In another example, the MIS 670 may fetch a model of the one or more ML models configured to make a determination regarding returning a cached prediction. In this regard, the model may determine a likelihood that a cached prediction will change based on data received since the cached prediction was generated. The model may be trained based on generated predictions from the one or more ML models. For instance predictions from an ETA model may be used to train an ETA caching model. The ETA caching model may be configured to parse what changes in received are likely to cause smaller or larger changes in a predicted ETA and generate a likelihood thereof. In this regard, the ETA caching model may control caching behavior based on the generated likelihood.

At block 1140, the method further includes in response to the calling, generating, by the first ML model, the first prediction based on the one or more token sequences. In this regard, the one or more ML models may be configured to make the one or more predictions based on one or more generated token sequences as discussed above. Additionally, the one or more predictions may be based on raw telemetry or data as discussed above with respect to the example ML models of the system.

In some instances, following the generation of the one or more predictions, the MIS 670 may then receive predictions from the one or more ML models. In some instances, the predictions may include predictions from multiple variants of an ML model of the one or more ML models. In such an instance, the MIS 670 may be configured to communicate the prediction from a primary model of the variants in response to the call.

Following the receipt of a prediction from the MIS 670, the event orchestration platform 680 may be to interact with the customer facing systems 690. In this regard, the event orchestration platform 680 may be configured to validate customer information (e.g., intended trips, asset and device intended locations etc.), trigger alerts based on the prediction (e.g., information validation alerts, trip status alerts, trip deviation alerts, etc.) and/or take one or more actions based on the predictions (e.g., order additional stock).

The systems and methodology described herein allow for a fully autonomous system for tracking assets including asset tags thereon. The system allows for such tracking with minimal to no input from users of customers of the system. Such a robust system is desirable to enable accurate tracking of assets and prediction of trip details without need for user inputs. Additionally, such a robust system may allow for validation of customer provided plans or routes. In this regard, when provided) the system may validate the plans or routes as well as to incorporate the inputted plans or route as data in order to modify the system behavior. For example, if a customer provides there are ten assets on a trip, the system may check this with respect to received payloads and provide an alert if, for example, one or more assets were left behind on a trip In another example, if a customer provides a trip will involve a stop sequence A, B, C, D the system may both i) take that as input to improve predictions (e.g., ETA to C knowing that there will be a stop at A and/or B first) and ii) check that this sequence actually happens and alert there is a deviation from this sequence. In this regard, customers may be provided systems and methodology to accurately track assets both with and without input.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method comprising:
receiving one or more payloads from one or more reader devices of an asset tracking system, wherein the one or more payloads include data pertaining to a status of at least one asset being tracked by the asset tracking system, the data including at least location information;
generating one or more token sequences based on the data included in the one or more payloads, wherein each generated token sequence includes one or more labels associated with the data;
calling, by an event orchestrion platform, a first machine learning (ML) model to generate a first prediction pertaining to the status of the at least one asset being tracked by the system, wherein the calling is based on at least one of i) receipt, by the asset tracking system, of a payload or ii) a prior generated prediction by a second ML model; and
in response to the calling, generating, by the first ML model, the first prediction based on the one or more token sequences.

2. The method of claim 1, wherein the first ML model is one of a trip inference model, a trip anomaly detection model, a destination recommendation model, an estimated time of arrival model, a conditions forecasting model, and a delivery detection model.

3. The method of claim 2, wherein the first ML model is the delivery detection model, wherein the delivery detection model is configured to predict when a delivery of a tracked asset has occurred.

4. The method of claim 3, wherein the prediction of the delivery occurrence is based at least one of: a geofence break, condition changes, “seen-by” events, and shipment-based network changes.

5. The method of claim 1, wherein the one or more payloads are received from a tracking tag affixed to the at least one asset.

6. The method of claim 1, wherein the data pertains to a plurality of assets being tracked by the asset tracking system.

7. The method of claim 1, wherein generating the one or more token sequences includes:
grouping the data based on a time interval when the data is received or grouping the data into buckets, wherein each bucket includes a collection of a predetermined number of data points; and
averaging each group of the data.

8. The method of claim 1, wherein generating the one or more token sequences includes:
generating a first plurality of tokens including a first type of information and a second plurality of tokens including a second type of information; and
concatenating the first plurality of tokens and the second plurality of tokens to generate a token sequence of the one or more token sequences.

9. The method of claim 8, wherein each token of the one or more token sequences includes the first type of information and the second type of information.

10. The method of claim 1, further comprising:
generating one or more alerts based on the first prediction; and
triggering an action based on the first prediction.

11. The method of claim 1, wherein:
calling, by the event orchestration platform, the first ML to generate the first prediction includes calling a third ML model to make a third prediction; and
generating, by the first ML model, the first prediction is further based on the third prediction.

12. The method of claim 1, further comprising:
calling, by the event orchestrion platform, a model inference service (MIS) configured to fetch one or more ML models; and
fetching by the MIS, a primary version of the first ML model and a secondary version of the first ML model,
wherein generating the first prediction based on the one or more token sequences includes generating a primary first prediction using the primary version of the first ML model and a secondary first prediction using the secondary first ML model.

13. The method of claim 1, wherein:
the data further includes one or more sensor measurements; and
at least one label of the one or more labels corresponds to the one or more sensor measurements.

14. The method of claim 1, wherein at least one label of the one or more labels corresponds to one or more specialized events.

15. The method of claim 1, wherein the first ML model and the second ML model are the same.

16. The method of claim 1, wherein the first ML model and the second ML model are different.

17. The method of claim 1, wherein the status of the at least one asset pertains to movement of the at least one asset from a point of origin to one or more final destinations or from a first state of the asset to a second state of the asset.

18. The method of claim 1, further comprising training the first ML model using non-specific training data.

19. The method of claim 18, further comprising training the first ML model using customer-specific training data.

20. An asset tracking system comprising:
one or more tracking tags configured to generate one or more payloads including data pertaining a status of at least one asset being tracked by the asset tracking system, wherein the data includes at least location information;
one or more readers configured to receive one or more payloads from the one or more tracking tags; and
one or more processors configured to:
receive one or more payloads from the one or more reader devices,
generate one or more token sequences based on the data included in the received one or more payloads, wherein each generated token sequence includes one or more labels associated with the data,
call, by an event orchestrion platform, a first machine learning (ML) model to generate a first prediction pertaining to the status of the at least one asset being tracked by the system, wherein the calling is based on at least one of i) receipt, by the asset tracking system, of a payload or ii) a prior generated prediction by a second ML model, and
in response to the call, generate, by the first ML model, the first prediction based on the one or more token sequences.
